(19) United States
(12) Patent Application Publication
(10) Pub. No.: US 2025/0220482 A1
(43) Pub. Date: Jul. 3, 2025

(54) METHODS FOR DYNAMIC CHANNEL STATE INFORMATION FEEDBACK RECONFIGURATION

(71) Applicant: Telefonaktiebolaget LM Ericsson (publ), Stockholm (SE)

(72) Inventors: Xinlin ZHANG, Göteborg (SE); David ASTELY, Bromma (SE); Mattias FRENNE, Uppsala (SE)

(21) Appl. No.: 18/853,312

(22) PCT Filed: Mar. 30, 2023
(86) PCT No.: PCT/SE2023/050285

§ 371 Date: Oct. 1, 2024

Related U.S. Application Data
(60) Provisional application No. 63/328,929, filed on Apr. 8, 2022.

(51) Int. Cl. H04W 24/10; H04L 5/00

(52) U.S. Cl. CPC H04W 24/10; H04L 5/0057

(57) ABSTRACT

Methods, network node and wireless device for dynamic Channel State Information (CSI) reconfiguration, for example codebook reconfiguration, are disclosed. According to one aspect, a method in a network node includes signaling a first set of CSI feedback generation configuration parameters and a second set of CSI feedback generation configuration parameters by higher layer signaling, such as radio resource control (RRC) signaling. The method also includes signaling an updated set of CSI feedback generation configuration parameters to update the second set of CSI feedback generation configuration parameters by control signaling, such as at least one of downlink control information (DCI), and at least one medium access control (MAC) control element (CE).

### TECHNICAL FIELD

The present disclosure relates to wireless communications, and in particular, to methods for dynamic Channel State Information (CSI) feedback reconfiguration.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

The 5^{th} generation mobile wireless communication system uses orthogonal frequency division multiplexing (OFDM) with configurable bandwidths and subcarrier spacing to efficiently support a diverse set of use-cases and deployment scenarios. In comparison to the 4^{th} generation system, NR improves deployment flexibility, user throughputs, latency, and reliability. The throughput performance gains are enabled, in part, by enhanced support for multiple antenna techniques such as Multi-User MIMO (MU-MIMO) transmission strategies, where two or more WD receive data on the same time frequency resources, i.e., via spatially separated transmissions.

The MU-MIMO transmission strategy is illustrated in FIG. 1, which is an example of a transmission and reception chain for MU-MIMO operations. Note that the order of modulation and precoding, or demodulation and combining respectively, may differ depending on the implementation of MU-MIMO transmission. A multi-antenna base station with N_{TX} antenna ports is simultaneously (on the same OFDM time-frequency resources) transmitting information to several WDs: the sequence S⁽¹⁾ is transmitted to WD(1), S⁽²⁾ is transmitted to WD(2), and so on. Before modulation and transmission, precoding W_{V}^{(j)} is applied to each sequence to mitigate multiplexing interference—the transmissions are spatially separated.

Each WD demodulates its received signal and combines receiver antenna signals to obtain an estimate Ŝ⁽ⁱ⁾ of transmitted sequence. This estimate Ŝ⁽ⁱ⁾ for WD i can be expressed as (neglecting other interference and noise sources except the MU-MIMO interference):

$${\hat{S}}^{( i )} = \underbrace{{W}_{U}^{( i )} {H}^{( i )} {W}_{V}^{( i )}}_{\approx I} {S}^{( i )} + {W}_{U}^{( i )} {H}^{( i )} {\sum }_{j , j \neq i} {W}_{V}^{( j )} {S}^{( j )}$$

The second term represents the spatial multiplexing interference (due to MU-MIMO transmission) seen by WD(i). The goal for the Network (NW) is to construct the set of precoders {W_{V}^{(j)}} to meet a given target. One such target is to make:
the norm ∥H⁽ⁱ⁾W_{V}⁽ⁱ⁾∥ large (this norm represents the desired channel gain towards user i); and
the norm ∥H^{(j)}W_{V}⁽ⁱ⁾∥,j≠i small (this norm represents the interference of user i's transmission received by user j).

In other words, the precoder W_{V}⁽ⁱ⁾ should correlate well with the channel H⁽ⁱ⁾ observed by WD(i) whereas it shall correlate poorly with the channels observed by other WDs.

To construct precoders W_{V}⁽ⁱ⁾, i=1, . . . , J that enable efficient MU-MIMO transmissions, the network (NW), e.g., network node, needs to obtain detailed information about all the users downlink channels H(i), i=1, . . . , J. There is also a need for information about the downlink channels, perhaps a bit less detailed, for the case with single user (SU) MIMO when there is only data to be transmitted to a single user.

In deployments where full channel reciprocity holds, detailed channel information can be obtained from uplink sounding reference signals (SRS) that are transmitted periodically, or on demand, by active WDs. The NW, such as via the network node, can directly estimate the uplink channel from SRS and, therefore (by reciprocity), the downlink channel H⁽ⁱ⁾.

However, the NW cannot always accurately estimate the downlink channel from uplink reference signals. Consider the following examples:
In frequency division duplex (FDD) deployments, the uplink and downlink channels use different carriers and, therefore, the uplink channel might not provide enough information about the downlink channel to enable MU-MIMO precoding;
In time division duplex (TDD), the NW might only estimate part of the uplink channel using SRS, because the WD typically has fewer transmit (TX) branches than receive (RX) branches (in which case only certain columns of the precoding matrix can be estimated using SRS). This is known as partial channel knowledge.

If the NW cannot accurately estimate the full downlink channel from uplink transmissions, then active WDs need to report channel information to the NW over the uplink. In LTE and NR, this feedback is achieved by the following signalling protocol:
The NW periodically transmits Channel State Information reference signals (CSI-RS) over the downlink using N ports;
The WD estimates the downlink channel for each of the N ports from the transmitted CSI-RS;
The WD reports CSI (e.g. channel quality indicator (CQI), as well as a precoder matrix indicator (PMI) and rank indicator (RI) of the precoder) to the NW over uplink (control or data) channel;
The NW uses the WD's feedback to select suitable precoders for downlink MU-MIMO transmissions.

In NR, both Type I and Type II reporting is configurable, where the CSI Type II reporting protocol has been specifically designed to enable MU-MIMO operations from uplink WD reports.

The CSI Type II normal reporting mode is based on the specification of sets of Discrete Fourier Transform DFT basis functions in a precoder codebook. The WD selects and reports the L DFT vectors from the codebook that best match its channel conditions (like the classical codebook precoding matrix indicator (PMI) from earlier 3GPP releases). The number of DFT vectors L is typically 2 or 4 and is configurable by the NW. In addition, the WD reports how the L DFT vectors should be combined in terms of relative amplitude scaling and co-phasing.

Algorithms to select L, the L DFT vectors, and co-phasing coefficients are outside the 3GPP NR Specification scope—left to WD and NW implementation. Or, put another way, the 3GPP Technical Release 16 (3GPP Rel-16) only defines signalling protocols to enable the above message exchanges.

In the following, the term “DFT beams” is used interchangeably with DFT vectors. This slight abuse of terminology is appropriate whenever the base station has a uniform planar array with antenna elements separated by half of the carrier wavelength.

The CSI type II normal reporting mode is illustrated in FIG. 2. The selection and reporting of the L DFT vectors bₙ and their relative amplitudes aₙ is done in a wideband manner; that is, the same beams are used for both polarizations over the entire transmission band. The selection and reporting of the DFT vector co-phasing coefficients is done in a subband manner; that is, DFT vector co-phasing parameters are determined for each of multiple subsets of contiguous subcarriers. The co-phasing parameters are quantized such that e^{jθ}^{ₙ} is taken from either a quadrature phase shift keying (QPSK) or eight-point phase shift keying (8PSK) signal constellation.

With k denoting a sub-band index, the precoder W_{V}[k] reported by the WD to the NW can be expressed as follows:

$${W}_{V} [ k ] = {\sum }_{n} {b}_{n} {a}_{n} {e}^{j {θ}_{n} [ k ]} .$$

The Type II CSI report can be used by the NW to co-schedule multiple WDs on the same OFDM time-frequency resources. For example, the NW can select WDs that have reported different sets of DFT vectors with weak correlations. The CSI Type II report enables the WD to report a precoder hypothesis that trades CSI resolution against uplink transmission overhead.

NR 3GPP Release 15 supports Type II CSI feedback using port selection mode, in addition to the above normal reporting mode. In this case:
The base station transmits a CSI-RS port in each one of the beam directions; and/or
The WD does not use a codebook to select a DFT vector (a beam); instead the WD selects one or multiple antenna ports from the CSI-RS resource of multiple ports.

Type II CSI feedback using port selection gives the base station some flexibility to use non-standardized precoders that are transparent to the WD. For the port-selection codebook, the precoder reported by the WD can be described as follows (excluding eventual normalization):

$${W}_{V} [ k ] = {\sum }_{n} {e}_{n} {a}_{n} {e}^{j {θ}_{n} [ k ]} .$$

Here, the vector e is a unit vector with only one non-zero element, which can be viewed as a selection vector that selects a port from the set of ports in the measured CSI-RS resource. The WD thus feeds back which ports it has selected, the amplitude factors and the co-phasing factors.

### CSI Reporting in NR

In NR, a WD can be configured with one or multiple CSI Report Settings, each configured by a higher layer parameter CSI-ReportConfig. Each CSI-ReportConfig is associated with a BWP and contains one or more of the following:
a CSI resource configuration for channel measurement;
a CSI-IM resource configuration for interference measurement;
reporting configuration type, e.g., aperiodic CSI (on a physical uplink shared channel (PUSCH)), periodic CSI (on a physical uplink control channel (PUCCH)), or semi-persistent CSI on PUCCH or PUSCH;
report quantity specifying what to be reported, such as RI, PMI, CQI;
codebook configuration such as type I or type II CSI;
frequency domain configuration, e.g., subband vs. wideband CQI or PMI, and subband size; and/or
CQI table to be used.

A WD can be configured with one or multiple CSI resource configurations for channel measurement and one or more CSI-IM resources for interference measurement. Each CSI resource configuration for channel measurement can contain one or more non-zero power (NZP) CSI-RS resource sets. For each NZP CSI-RS resource set, it can further contain one or more NZP CSI-RS resources. A NZP CSI-RS resource can be periodic, semi-persistent, or aperiodic.

Similarly, each CSI-IM resource configuration for interference measurement can contain one or more CSI-IM resource sets. For each CSI-IM resource set, it can further contain one or more CSI-IM resources. A CSI-IM resource can be periodic, semi-persistent, or aperiodic.

### Codebook Configuration in NR

In NR, the codebook is configured to the WD via the radio resource control (RRC) information element (IE) CodebookConfig, which specifies the type of codebook and the parameter setup of the configured codebook to be used by the WD for CSI reporting.

### Types of Codebooks

Currently, the supported types of codebooks are:
Type I codebook, which further contains the subtypes:
   Type I Single-Panel codebook;
   Type I Multi-Panel codebook;
Type II codebook, which further contains the subtypes:
   Type II codebook (a.k.a., 3GPP Rel-15 Type II codebook);
   Type II Port Selection codebook (a.k.a., 3GPP Rel-15 Type II Port Selection codebook);
   Enhanced Type II codebook (a.k.a., 3GPP Rel-16 Type II codebook);
   Enhanced Type II Port Selection codebook (a.k.a., 3GPP Rel-16 Type II Port Selection codebook); and/or
   Further enhanced Type II Port Selection codebook (a.k.a., 3GPP Rel-17 Type II Port Selection codebook)

### Codebook Parameters

Each type/subtype of codebook is associated with a set of parameters that are RRC configured together with the codebook type. In general, depending on the type of codebook, the parameters may contain one or multiple of the followings:
For Type I codebook:
   Subtype;
   Codebook subset restriction;
   Rank restriction;
   Codebook mode;
For Type II codebook:
   Subtype;
   Number of beams (for 3GPP Rel-15 Type II codebooks);
   Number of bits for quantizing each reported coefficient;
   Parameter combination (for 3GPP Rel-16/17 Type II codebooks);
   Number of PMI subbands per channel quality indicator (CQI) subband;
   Codebook subset restriction; and/or
   Rank restriction.

### Codebook Subset Restriction in NR

The codebook subset restriction (CBSR) indicates that a WD is not allowed to select certain entries from the precoder codebook, i.e., it restricts the PMI selection. This is useful for instance to control interference in certain spatial (beam) directions (for instance pointing to WDs of a neighboring cell) by restricting a WD from selecting a PMI corresponding to these directions. The CBSR is RRC configured to the WD in conjunction with configuring which precoder codebook to use for the CSI feedback. As the codebooks have gotten more and more complicated, the indication of CBSR has consumed more signaling overhead and various schemes have been devised to reduce the signaling load.

Other possible benefits of codebook subset restriction, not yet enabled by the 3GPP standard, could be that it reduces the feedback payload size and possibly also reduces the processing complexity since fewer entries need to be searched for. As will become apparent from what follows, different subsets could be used to cover different sectors of a cell and thus could reduce the feedback as compared to have a single codebook cover the entire cell and hence used by all terminals in the cell.

### CBSR for NR Type I Codebooks

In order to reduce codebook subset restriction (CBSR) signaling overhead, LTE FD-MIMO, as well as NR Type I CSI feedback, uses beam-based rank-agnostic CBSR signaling as opposed to PMI-based per-rank CBSR as was used in earlier releases of LTE. In PMI-based per-rank CBSR, precoders are restricted by signaling one or more bitmaps for each rank (e.g., 8 sets of bitmaps for ranks 1-8) and each bit in the bitmap restricts one PMI index (e.g., i1 or i2) for the codebook of a specific rank.

With beam-based rank-agnostic CBSR, on the other hand, the constituent 2D DFT beams v_{l,m} are restricted instead, resulting in a size N₁N₂O₁O₂ bitmap where each bit restricts a certain (l₀, m₀) index pair, corresponding to the beam vₗ_{₀}_{,m}_{₀}. Since the quantity v_{l,m} are the constructing blocks for precoders of all ranks, a substantial overhead reduction in CBSR signaling is attained. A precoder in the codebook is restricted if any of the restricted beams v_{l,m} is present in the precoder.

### CBSR for NR Type II Type II Codebooks

While the Type I CBSR uses beam restriction directly, with a size N₁N₂O₁O₂ bitmap being signalled where each bit in the bitmap corresponds to the restriction of a 2D DFT beam v_{l,m}, the existing NR Type II CBSR (both 3GPP Rel-15 and 3GPP Rel-16) uses joint beam and beam amplitude restriction, where the restricted beams can have soft amplitude threshold, 0, \sqrt{0.25}, \sqrt{0.5}, 1. The restricted beams for both 3GPP Rel-15 and 3GPP Rel-16 Type II codebooks are configured in the same way. That is, as seen in FIG. 3, 4 out of O₁O₂ beam groups (where O₁=O₂=4 in this example), with each group containing N₁N₂ orthogonal DFT beams, have amplitude restriction. In other words, a subset of 4N₁N₂ beams have amplitude restriction, while the remaining N₁N₂O₁O₂-4N₁N₂ beams have no such constraint. For each beam in this subset, a maximum amplitude value is configured, the corresponding amplitude cannot exceed this max value if this beam is to be included in the PMI. However, the beam amplitude calculation is somewhat different for the 3GPP Rel-15 and the 3GPP Rel-16 Type II CBSR. In 3GPP Rel-15, the amplitude for a beam is represented by the corresponding wideband amplitude coefficient p_{l,i}⁽¹⁾. As for 3GPP Rel-16, where a frequency-domain (FD) parametrized codebook structure is used, the amplitude for a beam is calculated by normalizing the squared sum of all the coefficients for all associated FD basis vectors with this beam, as follows:

$$\sqrt{\frac{1}{{\sum }_{f = 0}^{{M}_{υ} - 1} {k}_{l , i + pL , f}^{( 3 )}} {\sum }_{f = 0}^{{M}_{υ} - 1} {k}_{l , i + pL , f}^{( 3 )} {( {p}_{l , p}^{( 1 )} {p}_{l , i + pL , f}^{( 2 )} )}^{2}} \leq {γ}_{i + pL}$$

where l∈{1, . . . , v}, i∈{0, . . . , L−1}, p∈{0, 1}, and γ_{i+pL}∈{0, \sqrt{0.25}, \sqrt{0.5}, 1} is the maximum average coefficient amplitude. The beam-specific maximum amplitude value, for both 3GPP Rel-15 and 3GPP Rel-16 Type II, applies for both polarizations as well as for all layers. Detailed definition of the parameters in the above inequality can be found, for example, in 3GPP Technical Standard (TS) 38.214 Section 5.2.2.2.5.

### Autoencoders for AI/ML-Enhanced CSI Reporting

Recently, neural network based autoencoders (AEs) have shown promising results for compressing downlink MIMO channel estimates for uplink feedback. For example, AEs have been proposed to improve the accuracy of reported CSI from the WD to the NW. Moreover, 3GPP has decided to include “CSI feedback enhancement” in the scope of a study item.

An AE is a type of artificial neural network (NN) that can be used to compress and decompress data, in an unsupervised manner, often with high fidelity. FIG. 4 illustrates an example of a simple fully connected (dense) AE. The AE is divided into two parts:
an encoder (used to compress the input data X); and
a decoder (used to de-compress the input data).

AEs can have different architectures. For example, AEs can be based on dense neural networks (NNs), multi-dimensional convolution NNs, variational, recurrent NNs, transformer networks, or any combination thereof. However, all AE architectures possess an encoder-bottleneck-decoder structure illustrated in FIG. 5.

The size of the codeword (denoted by Y in FIG. 4) of an AE is typically a lot smaller than the size of the input data (X in FIG. 4). The AE encoder thus reduces the dimensionality of the input features X down to Y. The decoder part of the AE tries to invert the encoder and reconstruct X with minimal error, according to some predefined loss function.

FIG. 5 is a diagram that illustrates an example of how an AE might be used for artificial intelligence/machine learning (AI/ML)-enhanced CSI reporting in NR. The WD measures the channel in the downlink using CSI-RS. The WD estimates that channel for each subcarrier (SC) from each base station TX antenna port and at each WD RX antenna port. The estimate can be viewed as a three-dimensional channel tensor. The 3D channel tensor represents the MIMO channel estimated over several subcarriers (sic) and is input to the encoder.

The AE encoder is implemented in the WD, and the AE decoder is implemented in the NW. The output of the AE encoder is signalled from the WD to the NW over the uplink. The codeword can be viewed as a learned latent representation of the channel. Note that a quantization layer may be connected at the output of the encoder or directly included in the encoder, so that the codeword consists of quantized values that are transmitted to the network node as one part of a CSI report or as the entire CSI report.

The architecture of an AE (e.g., number of layers, nodes per layer, activation function, etc.) typically needs to be numerically optimized for CSI reporting via a process called hyperparameter tuning. Properties of the data (e.g., CSI-RS channel estimates), the channel size, uplink feedback rate, and hardware limitations of the encoder and decoder all should be considered when optimizing the AE's architecture.

The weights and biases of an AE (with a fixed architecture) are trained to minimize the reconstruction error (the error between the input X and output \hat{X}) on some training dataset. For example, the weights and biases can be trained to minimize the mean squared error (MSE) ∥X−\hat{X}∥². Model training is typically done using some variant of the gradient descent algorithm on a large training data set. To achieve good performance during live operation, the training data set should be representative of the actual data the AE will encounter during live operation.

The process of designing an AE (hyperparameter tuning and model training) can be expensive—consuming significant time, compute, memory, and power resources.

CAICT and OPPO's 3GPP contribution to the June 2021 RAN 3GPP Rel-18 Workshop, “Introduction of the 1^{st} wireless communication AI competition”, RWS-210236, summarizes a recent competition to design and train AEs specifically for CSI reporting in 3GPP networks. It was claimed that the competition involved more than 900 teams, comprised of 1175 contestants from 210 companies. The winning AE used a transformer based network to compress a 24,576 bit “raw” channel representation down to 286 bits at the WD (for uplink feedback), while still allowing the NW to reconstruct with a normalized mean square error of 0.1 or less.

AE-based CSI reporting is of interest for a 3GPP Rel. 18 “AI/ML on PHY” study item [9, 10, 11, 12, 13, 14, 15, 16, 17, 18, 19, 20, 21] for the following reasons:
AEs can include non-linear transformations (e.g., activation functions) that help improve compression performance and, therefore, MU-MIMO performance for the same uplink overhead. For example, the normal Type II CSI codebooks in 3GPP Rel. 16 are based on linear DFT transformations and SVD decompositions, which cannot fully exploit redundancies in the channel for compression;
AEs can be trained to exploit long-term redundancies in the propagation environment and/or site (e.g., antenna configuration) for compression purposes. For example, a particular AE does not need to work well for all possible deployments. Improved compression performance is obtained by learning which channel inputs it needs to (and doesn't need to) reliably reconstruct at the base-station;
AEs can be trained to compensate for antenna array irregularities, including, for example, non-uniformly spaced antenna elements and non-half wavelength element spacing. The Type II CSI codebooks in 3GPP Rel. 15 and 16, for example, use a two-dimensional DFT codebook designed for a regular planar array with perfect half wavelength element spacing;
AEs can be trained so that the used CSI reporting is more robust against, or updated (e.g., via transfer learning and training) to compensate for partially failing hardware as the massive MIMO product ages. For example, over time one or more of the multiple Tx and Rx radio chains in the massive MIMO antenna arrays at the base station will fail compromising the effectiveness of Type II CSI feedback;
AEs can be trained so that they are suitable for different channel conditions, for example, different parts of a cell. Then, instead of using a single AE for all terminals in the cell, different terminals could use different AEs depending on their channel conditions or where they are in the cell. The benefit of such an approach is that the feedback payload size could be reduced as compared to having feedback bits for the entire cell.

It should also be noted that the encoder can in fact be seen just as CSI feedback generator very much like Codebooks for type I and type II, one difference being that for the AE, the implementation of encoder is a neural network (and not an algorithm derived from models and first principles). In any case, like the types I and II, it can be envisioned that there the AEs have parameters that can be configured.

The current codebook configuration in 3GPP NR specification is configured to the WD via RRC signaling, which could happen just after the initial access phase or during handover procedures.

Oftentimes, even if the WD stays within the same cell or connected to the same transmission and reception point (TRP), the channel condition changes over time and the initial codebook configuration might be outdated/suboptimal after a while due to WD movement, etc.

In this case, an RRC reconfiguration of the codebook is used to get the accurate channel knowledge and at the same balance uplink signaling overhead and performance. This balance may be useful when multiple users are simultaneously served by the network node, i.e., via MU-MIMO scheduling in downlink.

### SUMMARY

Some embodiments advantageously provide methods, network nodes, and wireless devices for dynamic channel state information (CSI) feedback generation reconfiguration (for example codebook reconfiguration). An object of embodiments herein is to obviate some of the problems discussed above.

A first aspect of the invention provides a method implemented in a wireless device (WD). The method comprises receiving, by higher layer signaling from a network node, a first set of channel state information (CSI) feedback generation configuration parameters and a second set of CSI feedback generation configuration parameters. The method further comprises receiving, by control signaling from the network node, an updated set of CSI feedback generation configuration parameters to update the second set of CSI feedback generation configuration parameters. The method further comprises determining a CSI feedback generation configuration based at least in part on the first set of CSI feedback generation configuration parameters and the updated set of CSI feedback generation configuration parameters.

A second aspect of the invention provides a method implemented in a network node configured to communicate with a wireless device (WD). The method comprises signaling, by higher layer signaling to the WD, a first set of channel state information (CSI) feedback generation configuration parameters and a second set of CSI feedback generation configuration parameters. The method further comprises signaling, by control signaling to the WD, an updated set of CSI feedback generation configuration parameters to update the second set of CSI feedback generation configuration parameters.

A third aspect of the invention provides a wireless device (WD) configured to communicate with a network node. The WD is configured to, and/or comprising a radio interface and/or processing circuitry configured to receive, by higher layer signaling from the network node, a first set of channel state information (CSI) feedback generation configuration parameters and a second set of CSI feedback generation configuration parameters. The WD is further configured to, and/or the radio interface and/or processing circuitry is further configured to receive, by control signaling from the network node, an updated set of CSI feedback generation configuration parameters to update the second set of CSI feedback generation configuration parameters. The WD is further configured to, and/or the radio interface and/or processing circuitry is further configured to determine a CSI feedback generation configuration based at least in part on the first set of CSI feedback generation configuration parameters and the updated set of CSI feedback generation configuration parameters.

A fourth aspect of the invention provides a network node configured to communicate with a wireless device (WD). The network node is configured to, and/or comprising a radio interface and/or comprising processing circuitry configured to signal, by higher layer signaling to the WD, a first set of channel state information (CSI) feedback generation configuration parameters and a second set of CSI feedback generation configuration parameters. The network node is further configured to, and/or the radio interface and/or comprising processing circuitry is further configured to signal, by control signaling to the WD, an updated set of CSI feedback generation configuration parameters to update the second set of CSI feedback generation configuration parameters.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an illustration of a transmission and reception chain.

FIG. 2 is an illustration of CSI type II feedback.

FIG. 3 is an illustration of beam group based CBSR for 3GPP Rel-15.

FIG. 4 is an illustration of a fully connected autoencoder.

FIG. 5 is an illustration of using an autoencoder for CSI compression.

FIG. 6 is a schematic diagram of an example network architecture illustrating a communication system connected via an intermediate network to a host computer according to the principles in the present disclosure.

FIG. 7 is a block diagram of a host computer communicating via a network node with a wireless device over an at least partially wireless connection according to some embodiments of the present disclosure.

FIG. 8 is a flowchart illustrating example methods implemented in a communication system including a host computer, a network node and a wireless device for executing a client application at a wireless device according to some embodiments of the present disclosure.

FIG. 9 is a flowchart illustrating example methods implemented in a communication system including a host computer, a network node and a wireless device for receiving user data at a wireless device according to some embodiments of the present disclosure.

FIG. 10 is a flowchart illustrating example methods implemented in a communication system including a host computer, a network node and a wireless device for receiving user data from the wireless device at a host computer according to some embodiments of the present disclosure.

FIG. 11 is a flowchart illustrating example methods implemented in a communication system including a host computer, a network node and a wireless device for receiving user data at a host computer according to some embodiments of the present disclosure.

FIG. 12 is a flowchart of an example process in a network node for methods for dynamic codebook reconfiguration.

FIG. 13 is a flowchart of an example process in a wireless device for methods for dynamic codebook reconfiguration.

FIG. 14 is a flowchart of an example process in a network node and WD.

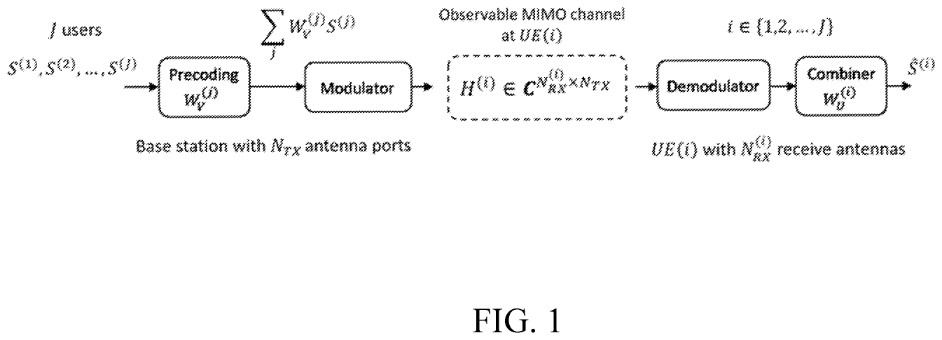

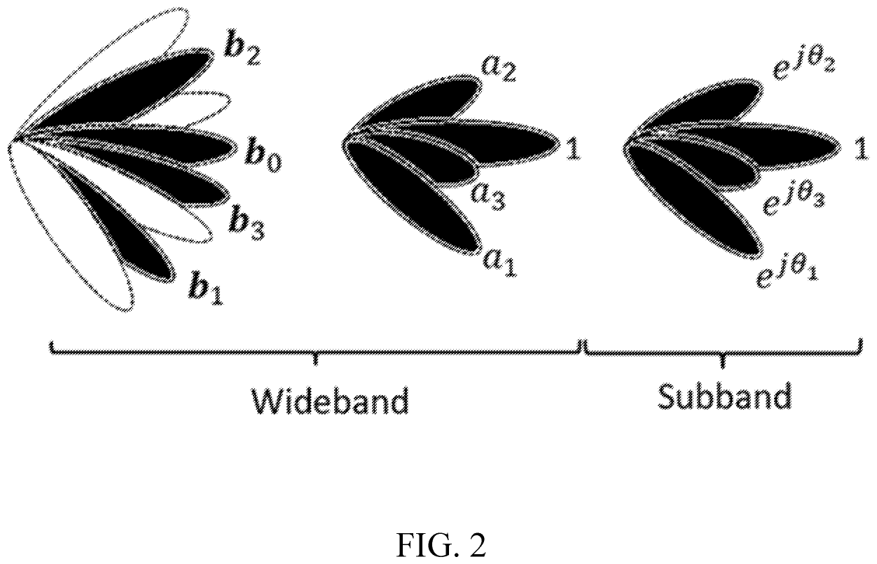

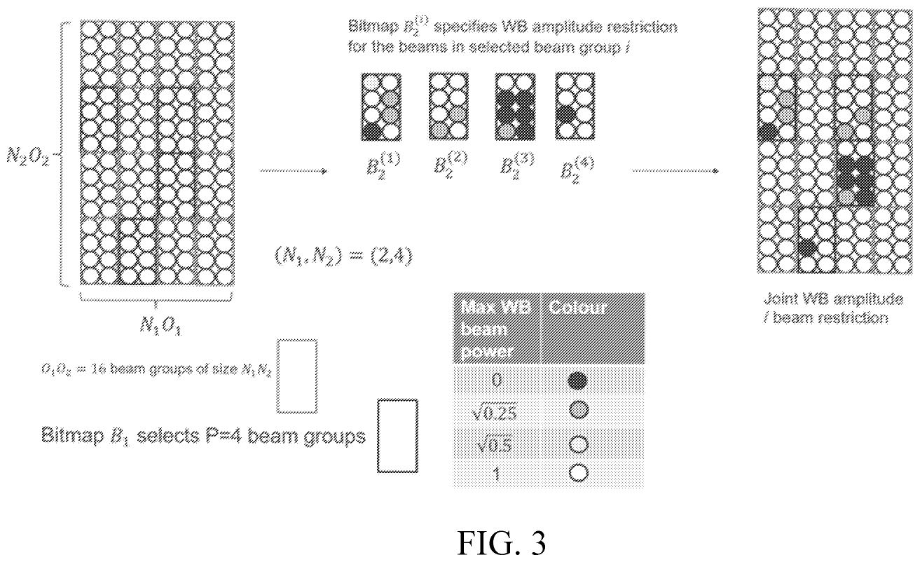

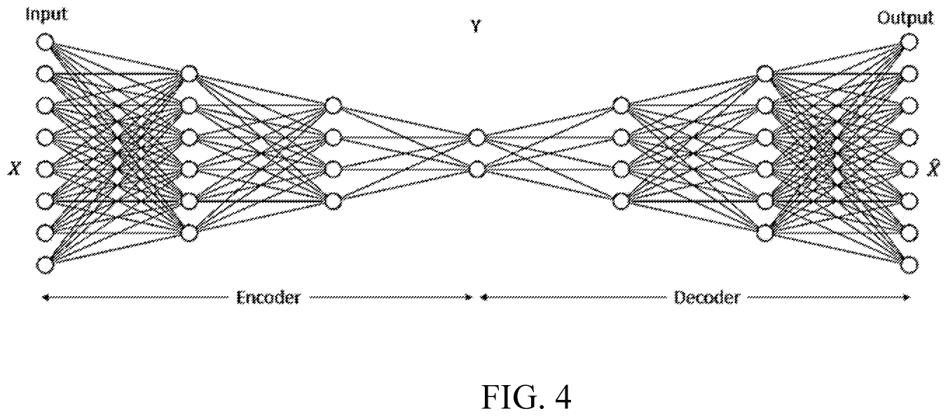

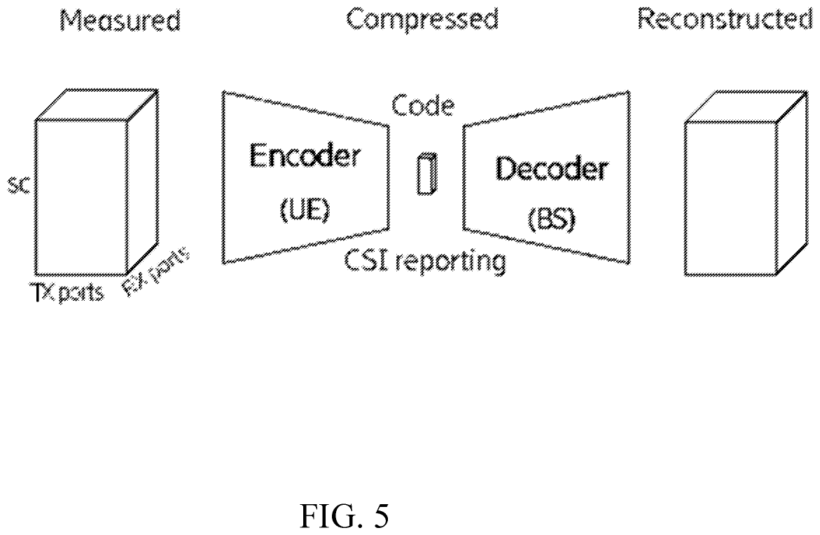

### DETAILED DESCRIPTION

In the current 3GPP NR specifications, the RRC configuration may need to reconfigure all the codebook parameters, even though many of the initial codebook parameters are still relevant and need not be changed.

In addition, RRC signaling is slow (from the time of sending the RRC message to the time where the WD has applied the new codebook). Hence, it is a problem to use RRC when the channel changes fast.

One solution is that the network node can RRC configure multiple codebook configurations to the WD (one per CSI report setting), and then use downlink control information (DCI) to trigger different codebook configurations (each associated with a CSI report setting configuration). However, this is still cumbersome since the network node may need to RRC configure many codebook configurations so that different channel conditions are considered.

In addition, WDs typically support one configuration for each type, e.g., one Type-I codebook, one Type-II codebook and for an advanced WD implementation, also a Type-II port selection codebook configuration. Hence, it is not possible to use this DCI based switching between e.g., two different configurations of a Type-II codebook, since WD can only be configured with one at a time. This restriction is due to the high WD complexity to support a Type-II codebook. Hence it is restricted to a single codebook. Therefore, to change a Type-II codebook, RRC reconfiguration is necessary.

Thus, existing approaches to configuration of feedback generation are slow and require high overhead for the case with multiple configurations, since all parameters should be set for each configuration. Similar problems are applicable for CSI feedback using autoencoders that assume that there is a set of autoencoders that are parameterized by a (large) number of parameters.

Another aspect of using multiple codebook configurations is that the overhead, in terms of the number of bits in the feedback report, depends on the used codebook. By constraining the codebook, for example in terms of the number of beams or the number of allowed entries in the codebook, the feedback overhead can be reduced. For example, for a terminal in a line of sight (LOS) with a strong direct propagation path, a very small codebook allowing only low rank feedback is sufficient, whereas, a terminal in non-LOS in a rich scattering environment would benefit from a large codebook with many feedback bits. Thus, existing solutions do not allow the benefit of UL overhead reduction that adapts to the channel without using RRC signaling. This is a problem since RRC signaling introduces significant delays and DL overhead.

Processing and energy consumption, primarily in the terminal, is also of concern since generating unnecessary large number of bits is more demanding on processing load and energy consumption.

To obviate some of the problems discussed above, some embodiments herein advantageously provide methods, network nodes, and wireless devices for dynamic CSI feedback generation reconfiguration (for example codebook reconfiguration).

Some embodiments have two parts 1) to introduce support for dynamic reconfiguration (faster than RRC) of parameters that defines a codebook for CSI reporting and 2) possibility to alter only a subset of these parameters that are used to define and generate the CSI feedback (e.g., codebook parameters) in an already configured codebook/CSI report setting.

This can be done via dynamic signaling, e.g., MAC CE and/or DCI. Prior to using MAC CE and/or DCI, semi-static signaling may be used to setup parameters including defining reconfigurable subsets of parameters (and ranges) while some parameters cannot be changed dynamically and are left as configured by RRC.

In some embodiments, the network node dynamically determines which parameters to use partially based on feedback parameters recommendations signaled from the terminal, e.g., according to AI/ML algorithms, to the network node.

In some embodiments:
The WD is configured with a codebook by a set of parameters using RRC signaling from the network node.
   The configuration may contain a first set of parameters that can only be changed by another RRC reconfiguration of the whole codebook and a second set of parameters that can subsequently be further determined by MAC-CE and/or DCI.
   For the second set, multiple candidate values for one or multiple of such parameters can be configured by the RRC.
   Alternatively, the second set of parameters contains default parameters that are subject to dynamic reconfiguration.
The WD receives reconfiguration message/indication messages from the network node, of the one or more of the second set of codebook parameters has been received, e.g., by receiving MAC-CE and/or DCI.
The WD determines a new codebook configuration based on this message by combining the first set of codebook parameters from those of the latest codebook configuration using RRC from the network, together with the second set of codebook parameters as indicated by MAC-CE and/or DCI. If the second set of parameters already have values configured in the codebook, then these may be overwritten by those indicated from the network node in the received reconfiguration message.
The WD determines a CSI report based on the new codebook configuration and transmits the CSI report to the network.
Optionally, the WD further evaluates the one or more of the parameters in the second set of parameters (such as codebook parameters) to generate recommended parameter values and signals this recommendation to the network.

In some embodiments:
After a codebook configuration has been configured to the WD by the network using RRC signaling using a first and second set of parameters, the network node determines the one or more of the parameters in the second set of parameters that should be updated to optimize the performance, CSI reporting overhead, PUSCH overhead, and WD battery consumption.
The network node may transmit the updated second set of one or more codebook parameters to the WD via dynamic signaling, e.g., MAC-CE, DCI.
Optionally, the network node receives from the WD the recommended parameter values within the second set of one and more parameters and uses them to determine the updated second set of codebook parameters.
Optionally, based on the newly configured codebook, the network node computes the new CSI report payload and use this to determine the PUSCH and/or PUCCH resource allocation for the WD to report CSI. In this way the uplink overhead is adapted to the new codebook payload.

According to some methods disclosed herein, dynamic reconfiguration of the codebook configuration with limited overhead is enabled, so that the CSI report (including PMI, CQI, RI, etc.) is up to date with the time varying channel characteristics. Furthermore, some methods disclosed herein allow reducing/optimizing the overhead of the CSI report, PUSCH resource overhead and WD battery consumption.

Before describing in detail example embodiments, it is noted that the embodiments reside primarily in combinations of apparatus components and processing steps related to methods for dynamic codebook reconfiguration. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide methods for dynamic codebook reconfiguration.

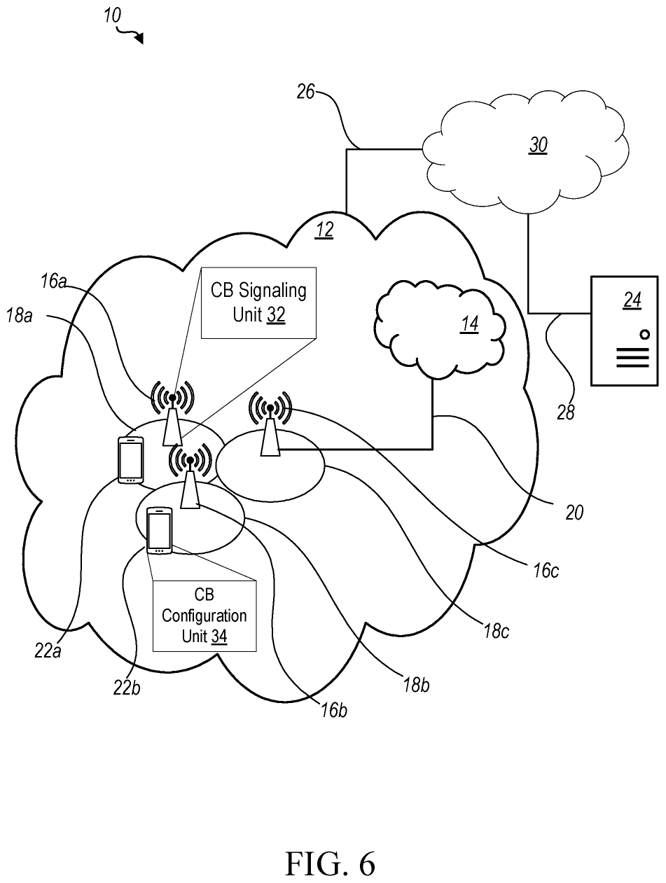

Referring again to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a codebook (CB) signaling unit 32 which is configured to signal an updated set of codebook configuration parameters to update the second set of codebook configuration parameters by control signaling, such as at least one of downlink control information, DCI, and at least one medium access control, MAC, control element, CE. A wireless device 22 is configured to include a CB configuration unit 34 which is configured to determine a codebook configuration based on the first set of codebook configuration parameters and the updated set of codebook configuration parameters.

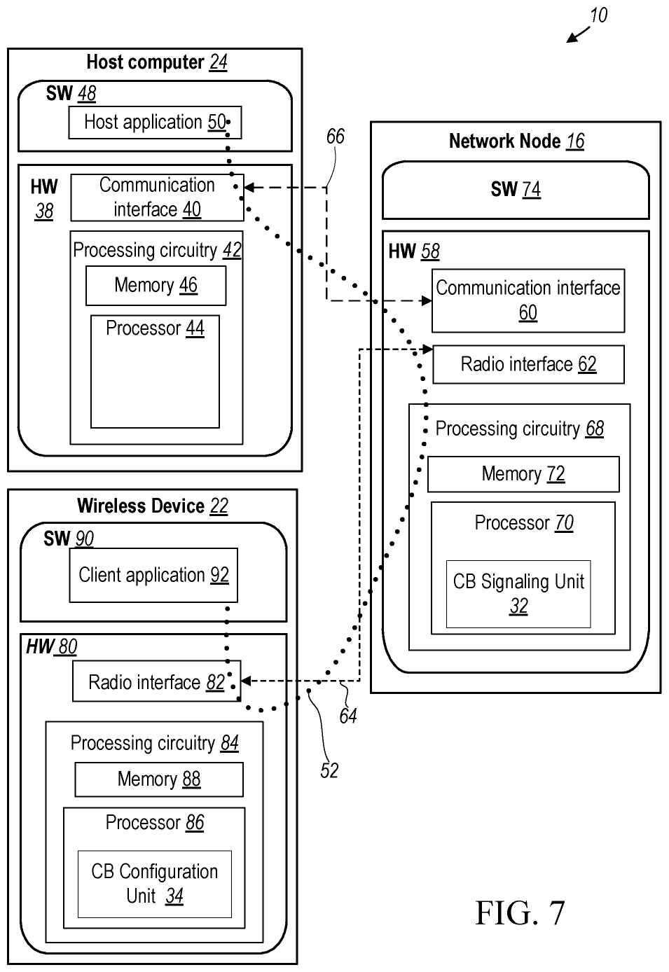

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a codebook (CB) signaling unit 32 which is configured to signal an updated set of codebook configuration parameters to update the second set of codebook configuration parameters by control signaling, such as at least one of downlink control information, DCI, and at least one medium access control, MAC, control element, CE.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a CB configuration unit 34 which is configured to determine a codebook configuration based on the first set of codebook configuration parameters and the updated set of codebook configuration parameters.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as CB signaling unit 32, and CB configuration unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

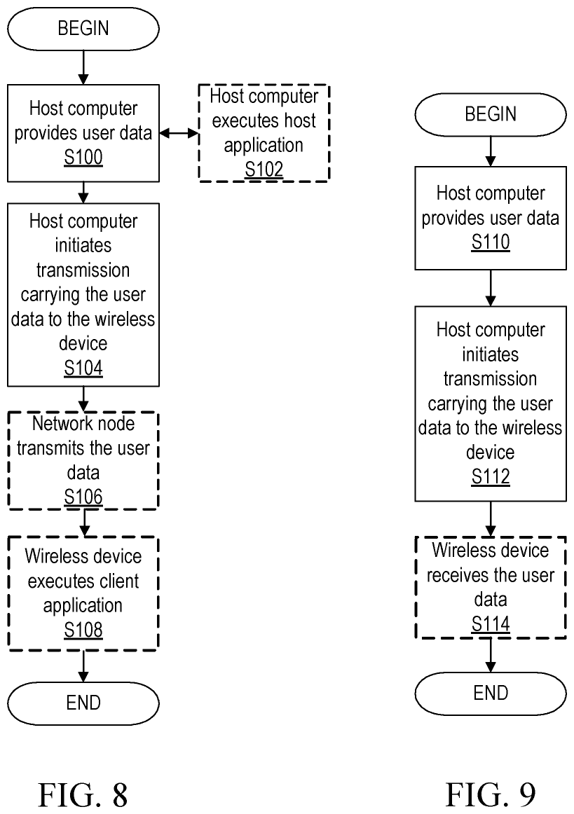

FIG. 8 is a flowchart illustrating an example method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

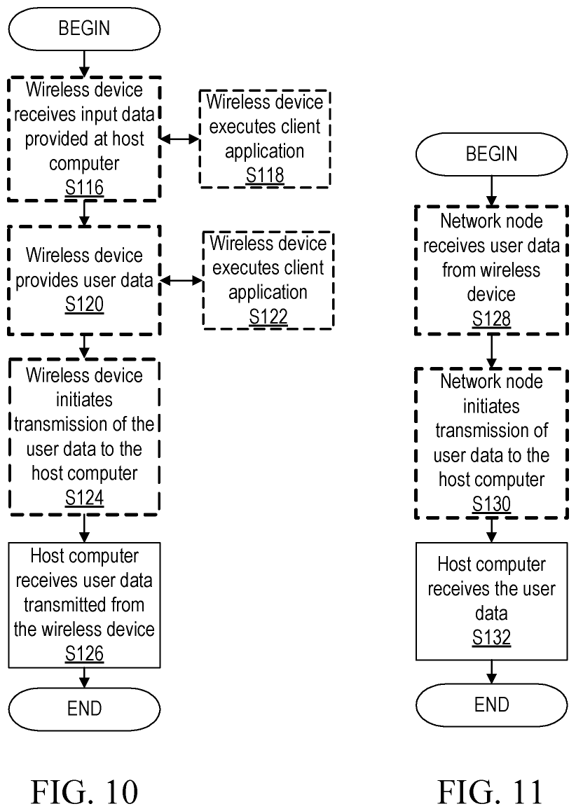

FIG. 10 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally, or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

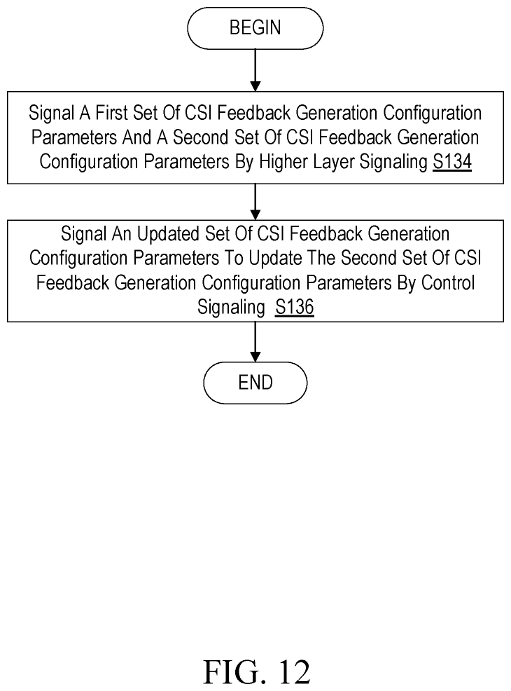

FIG. 12 is a flowchart of an example process in a network node 16 for methods for dynamic CSI feedback generation reconfiguration, for example dynamic codebook reconfiguration. One or more blocks described herein may be performed by one or more elements of network node 16 such as by one or more of processing circuitry 68 (including the CB signaling unit 32), processor 70, radio interface 62 and/or communication interface 60. Network node 16 such as via processing circuitry 68 and/or processor 70 and/or radio interface 62 and/or communication interface 60 is configured to signal a first set of Channel State Information (CSI) feedback generation configuration parameters (for example codebook configuration parameters) and a second set of CSI feedback generation configuration parameters by higher layer signaling (Block S134). The process also includes signal an updated set of CSI feedback generation configuration parameters to update the second set of CSI feedback generation configuration parameters by control signaling at least one of downlink control information, DCI, and at least one medium access control, MAC, control element, CE (Block S136).

In some embodiments, the higher layer signaling is radio resource control, RRC, signaling and/or the control signaling includes at least one of downlink control information, DCI and at least one medium access control, MAC, control element, CE. In some embodiments, the process also includes receiving from the WD recommended codebook configuration parameters and determining the updated set of codebook configuration parameters based at least in part on the WD-recommended codebook configuration parameters. In some embodiments, the method also includes determining at least one of a physical uplink shared channel, PUSCH, resource allocation and a physical uplink control channel, PUCCH, resource allocation for the WD, based at least in part on a CSI report payload size. In some embodiments, the second set of codebook configuration parameters and the updated codebook configuration parameters include at least one of: a number of beams, a number of frequency domain basis vectors, a codebook subset restriction and a rank restriction.

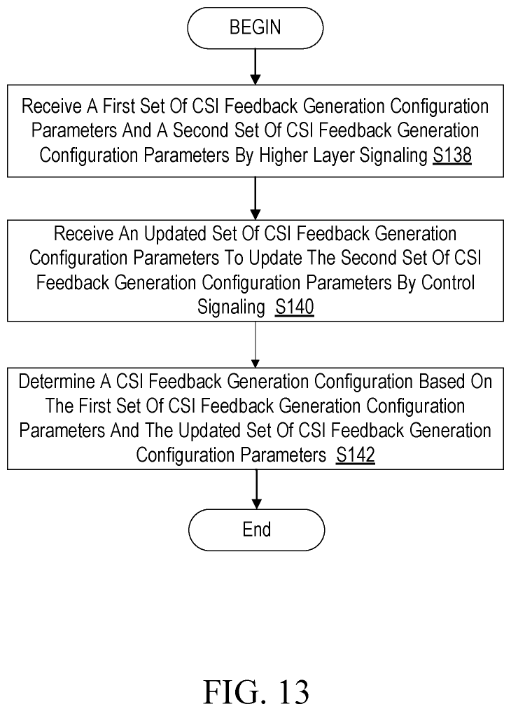

FIG. 13 is a flowchart of an example process in a wireless device 22 according to some embodiments of the present disclosure. One or more blocks described herein may be performed by one or more elements of wireless device 22 such as by one or more of processing circuitry 84 (including the CB configuration unit 34), processor 86, radio interface 82 and/or communication interface 60. Wireless device 22 such as via processing circuitry 84 and/or processor 86 and/or radio interface 82 is configured to receive a first set of Channel State Information (CSI) feedback generation configuration parameters (for example codebook configuration parameters) and a second set of CSI feedback generation configuration parameters by higher layer signaling (Block S138). The process also includes receiving an updated set of CSI feedback generation configuration parameters to update the second set of CSI feedback generation configuration parameters control signaling (Block S140). The process also includes determining a CSI feedback generation configuration (for example codebook configuration) based on the first set of CSI feedback generation configuration parameters and the updated set of CSI feedback generation configuration parameters (Block S142).

In some embodiments, the higher layer signaling is radio resource control, RRC, signaling and/or the control signaling includes at least one of downlink control information, DCI and at least one medium access control, MAC, control element, CE. In some embodiments, the method also includes signaling recommended codebook configuration parameters to the network node to update the second set of configuration parameters. In some embodiments, the method also includes receiving a channel state information, CSI, report payload indication size that is based at least in part on the updated set of codebook configuration parameters. In some embodiments, the second set of codebook configuration parameters and the updated codebook configuration parameters include at least one of: a number of beams, a number of frequency domain basis vectors, a codebook subset restriction and a rank restriction.

Having described the general process flow of arrangements of the disclosure and having provided examples of hardware and software arrangements for implementing the processes and functions of the disclosure, the sections below provide details and examples of arrangements for methods for dynamic codebook reconfiguration.

Some embodiments provide methods for dynamic codebook reconfiguration. Note that although the term codebook configuration is used herein, the term “codebook” may be interpreted broadly in some embodiments. “Codebook configuration” may be interpreted as a configuration configured by the network node 16 that can be used by the WD 22 to generate CSI feedback. The term “codebook configuration” is used in legacy 3GPP specifications (such as 3GPP Rel-17 and earlier releases), where CSI feedback is based on configured codebooks (e.g., Type I and Type II codebooks). However, if AI/ML-based CSI feedback is introduced, the term “codebook” may not be precise since there might be no predefined codebooks for AI/ML-based CSI feedback.

A proper CSI feedback generation configuration, such as codebook configuration, may be useful for the WD 22 to report accurate channel state information to the network node 16 with a reasonable overhead. A good codebook configuration may desirably be in line with, among other things, the characteristics of the propagation channel and the application of interest.

For example, when MU-MIMO is intended, a Type II CSI is more suitable than a Type I CSI. Furthermore, in this case, the configured Type II CSI parameters may also reflect the characteristics of the channel: if the channel only contains one or two dominant paths, then it is sufficient for the network node 16 to configure L=2 beams to the WD 22 to capture all the paths in the reported PMI; however, if the channel has richer scattering with more dominant paths, then a larger number of beams shall be configured.

Angular, delay and doppler spread/distribution, etc., are long-term channel properties, which, even for FDD operations, can be considered reciprocal between the DL and the UL. Therefore, they can be used by the network node 16 to determine proper codebook parameters, such as the number of beams, the number of delay taps (FD basis vectors), the measurement/reporting periodicity, etc. The determined codebook parameters can be configured to the WD 22 via RRC signaling so that the WD 22 can compute a CSI report that fits the given channel.

Due to WD 22 movement, dynamically changing environment, etc., the propagation channel usually changes over time. Thus, a good codebook configuration may become outdated or suboptimal after a while. Continuing with the above example with Type II codebook, when a stationary WD 22 initially connects to the network node 16 or performs handover from one network node 16 to another, the WD 22 may be within line-of-sight (LoS) of the target network node 16. Then the network node 16 will configure a Type II codebook with L=2 beams to the WD 22 via RRC signaling.

Then, even if the WD 22 is served with one and the same network node 16, the LoS path might be blocked by some newly parked vehicle, for example, and a number of non-LoS (NLoS) paths become dominant. It might be good in this case (to maintain or increase downlink throughput) for the network node 16 to reconfigure larger number of beams, for example, L=6, to this WD 22, while all the other codebook parameters may remain the same. This increases the feedback overhead since more channel directions are reported, and consumes more resources in the UL, such as PUSCH, if the PUSCH carries the CSI report. Also, the WD 22 battery power consumption increases since more computations are needed. The benefit of this is that the downlink throughput is maintained or even increased compared to the LoS case.

After a while, when the parking vehicle moves away, and the LoS path becomes dominant again, the network node 16 may want to reconfigure the number of beams to L=2 again. Otherwise, the WD 22 may need to spend unnecessarily large overhead for reporting PMIs associated with weak paths, etc. Also, WD 22 battery power consumption may be unnecessarily high to compute the L=6 report.

To make the above dynamic reconfiguration of L parameter, the current 3GPP NR specification requires reconfiguration of RRC, which requires another CSI-ReportConfigId than the one being used in the CSI report configuration, which links to another codebook configuration that contains all the codebook parameters. This introduces large overhead since, especially considering that only the value of L, i.e., the number of beams, needs to be changed.

Alternatively, the network node 16 can configure multiple codebook configurations, each associated with a CSI report setting, and then DCI 1_0 can be used to dynamically switch the report setting. However, this requires all the codebook configurations and, hence the CSI report configurations, to be pre-configured via an RRC message.

In light of this, methods for dynamic reconfiguration of codebook parameters are disclosed herein. Reconfiguring the number of beams may be viewed as an example, but other codebook parameters, such as the number of FD basis vectors, the codebook subset restriction, the rank restriction, etc., may also be reconfigured.

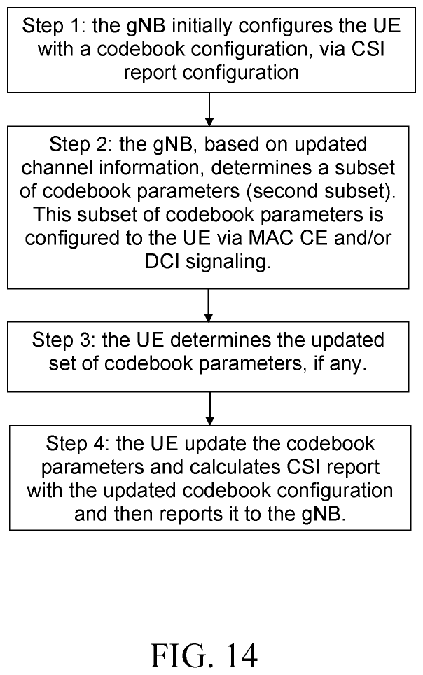

A general procedure of dynamic reconfiguration of codebook parameters proposed herein can be summarized in the flowchart of FIG. 14.

When the WD 22 receives this new dynamic reconfiguration message, which can be conveyed to the WD 22 via, e.g., MAC-CE and/or DCI signalling, the WD 22 may first identifies the codebook parameter(s) that have been reconfigured, if any. Then the reconfigured codebook parameter(s) may overwrite the corresponding codebook parameter(s) that are the latest. The WD 22 may then determine a CSI report based on the (2^{nd} set of) reconfigured codebook parameter(s) together with the (1^{st} set of) previously configured codebook parameters that cannot be changed during the MAC/DCI reconfiguration.

The flow chart of FIG. 14 may be supplemented as follows:
Between Step 1 and Step 2, the WD 22 may determine the CSI report according to the initial codebook configuration;
If the WD 22 does not detect any codebook parameter reconfiguration, then the WD 22 may determine the CSI report based on the latest codebook configuration;
If the WD 22 identifies a set of codebook parameters that have been reconfigured, the reconfigured codebook parameters may overwrite the corresponding codebook parameters from the latest codebook configuration. The remaining codebook parameters that are not reconfigured may follow the corresponding codebook parameters from the latest codebook configuration. The above two parts of codebook parameters may make up the updated codebook configuration;
FIG. 14 can be implemented iteratively; the updated codebook configuration in Step 4 becomes the initial codebook configuration in Step 1, until a new dynamic reconfiguration of codebook parameters is received.

Some additional embodiments may include:

In one embodiment, the updated channel information is based on an UL channel measurement that is obtained after the codebook configuration has been configured.

In another embodiment, the updated channel information is based on a CSI report from the WD 22. In this case, new report quantities may be introduced for CSI reporting that can be added on top of the currently supported report quantities. For example, the WD 22 may recommend codebook parameters, such as the number of beams, the number of FD basis vectors, codebook subset restriction, etc., to the network node 16. In NR 3GPP specifications, the corresponding report quantities can be, for example, L, M, CBSR, respectively. In one embodiment, the WD 22 is configured with CSI report quantity channel state resource indicator (CRI)-RI-PMI-CQI-L, or CRI-RI-PMI-CQI-M, or CRI-RI-PMI-CQI-CBSR.

Alternatively, the new report quantity may contain only the WD 22 recommended codebook parameters. In one embodiment, the new report quantity that includes WD-recommended codebook parameter can be reported in UL MAC CE. In another embodiment, the new report quantity that includes a WD-recommended codebook parameter can be reported in uplink control information (UCI).

In one embodiment, the network node 16 can determine a new PUSCH and/or PUCCH allocation size for the WD 22 to transmit the CSI report, e.g., based on the WD 22 recommendation of codebook parameters. This enables the network node 16 to dynamically change the resource allocation to fit the varying channel, thereby saving overhead. If this dynamic changing of PUSCH and/or PUCCH resource allocation is not present, then the UL payload is fixed, and reducing the payload size for the CSI report may have a benefit of allowing a more robust coding scheme (e.g., lower code rate for UCI).

In one embodiment, a one-bit indicator can be used to indicate if any codebook parameters have been reconfigured. For example, “0” may indicate no reconfiguration of codebook parameters, while “1” may indicate that there exists a set of codebook parameters that have been reconfigured. In some embodiments, when reconfiguration of codebook parameters exists, a bitmap can be used to indicate which parameters have been reconfigured, where the size of the bitmap equals the number of codebook parameters that are allowed to be reconfigured. A benefit of this two-step approach is to reduce overhead when there is nothing reconfigured.

In another embodiment, a bitmap is directly used to indicate which parameters have been reconfigured, where the size of the bitmap equals the number of codebook parameters that are allowed to be reconfigured.

In one embodiment, a bit field is used to indicate the reconfigured values of codebook parameters.

In one embodiment, the network node 16 can RRC configure a codebook configuration. Then, a CSI report configuration may contain one or multiple parameters, where each such parameter contains multiple candidate values, either by default (or by MAC or DCI), or the possible values are configured by the RRC configuration.

For each sub-parameter, the network node 16 configures a default value via RRC. Then the WD 22 can recommend a new value for a parameter to the network node 16. Then the network node 16 can dynamically configure the recommended new value of the parameter to the WD 22 via DCI or MAC CE. To further exemplify this, the WD 22 may be configured via RRC a machine learning model for CSI reporting, where the configured machine learning model may contain a number of sub-models. Each sub-model may be suitable for a different channel condition. Then, the network node 16 in the initial RRC configuration can specify a default sub-model that the WD 22 is to use. Based on the channel measurements, the WD 22 may recommend to the network node 16 a new sub-model. The network node 16, according to the WD 22 recommendation, may reconfigure the sub-model ID to the WD 22 via DCI or MAC CE, without modifying any other parameters in the CSI report setting.

In one embodiment, the reconfigured codebook parameters may contain one or multiple of the followings:
The number of selected beams;
The number of selected frequency domain (FD) basis vectors;
Codebook parameter combination;
The number of selected CSI-RS ports;
The number of PMI subbands per CQI subband;
The codebook subset restriction;
The rank restriction;
When a neural network based CSI reporting is configured, besides the above, one or more of the followings may be additionally reconfigured:
   Model ID indicating a combination of architecture and parameters;
   Quantity for a given feature;
   Compression ratio; and/or
   Loss function.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### ABBREVIATION EXPLANATION

3GPP 3^{rd} Generation Partnership Project
AE Auto Encoder
AI Artificial Intelligence
BS Base station
CE Channel Estimate
DFT Discrete Fourier Transform
CIR Channel impulse response
CSI Channel state information
CSI-RS Channel state information reference signal
DC Dual Connectivity
DL Downlink
eNB Evolved NodeB
E-UTRAN Evolved Universal Terrestrial Radio Access Network
gNB A radio base station in NR.
LTE Long term evolution
MIMO Multiple Input Multiple Output
ML Machine Learning
MU-MIMO Multi User-Multiple Input, Multiple Output
NMSE Normalized Mean Square Error
NR New radio
NW Network
OAM Operation and Maintenance
PCA Principal Component Analysis
PMI Precoder Matrix Indicator
RI Rank Indicator
RAN Radio access network
RL Reinforcement Learning
SINR Signal to interference and noise ratio
SN Secondary node
UE User equipment
UL uplink

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### NUMBERED EMBODIMENTS

Embodiment A1. A network node configured to communicate with a wireless device, WD, the network node configured to, and/or comprising a radio interface and/or comprising processing circuitry configured to:
signal a first set of codebook configuration parameters and a second set of codebook configuration parameters by, higher layer signaling; and
signal an updated set of codebook configuration parameters to update the second set of codebook configuration parameters, by control signaling.

Embodiment A2. The network node of Embodiment A1, wherein the higher layer signaling is radio resource control, RRC, signaling and/or the control signaling includes at least one of downlink control information, DCI and at least one medium access control, MAC, control element, CE.

Embodiment A3. The network node of any of Embodiments A1 and A2, wherein the network node, radio interface and/or processing circuitry are further configured to receive from the WD recommended codebook configuration parameters and to determine the updated set of codebook configuration parameters based at least in part on the WD-recommended codebook configuration parameters.

Embodiment A4. The network node of Embodiment A3, wherein the network node, radio interface and/or processing circuitry are further configured to determine at least one of a physical uplink shared channel, PUSCH, resource allocation and a physical uplink control channel, PUCCH, resource allocation for the WD, based at least in part on a CSI report payload size.

Embodiment A5. The network node of any of Embodiments A1-A4, wherein the second set of codebook configuration parameters and the updated codebook configuration parameters include at least one of: a number of beams, a number of frequency domain basis vectors, a codebook subset restriction and a rank restriction.

Embodiment B1. A method implemented in a network node configured to communicate with a wireless device, WD, the method comprising:
signaling a first set of codebook configuration parameters and a second set of codebook configuration parameters by higher layer signaling; and
signaling an updated set of codebook configuration parameters to update the second set of codebook configuration parameters by control signaling.

Embodiment B2. The method of Embodiment B1, wherein the higher layer signaling is radio resource control, RRC, signaling and/or the control signaling includes at least one of downlink control information, DCI and at least one medium access control, MAC, control element, CE.

Embodiment B3. The method of any of Embodiments B1 and B2, further comprising receiving from the WD recommended codebook configuration parameters and determining the updated set of codebook configuration parameters based at least in part on the WD-recommended codebook configuration parameters.

Embodiment B4. The method of Embodiment B3, further comprising determining at least one of a physical uplink shared channel, PUSCH, resource allocation and a physical uplink control channel, PUCCH, resource allocation for the WD, based at least in part on a CSI report payload size.

Embodiment B5. The method of any of Embodiments B1-B4, wherein the second set of codebook configuration parameters and the updated codebook configuration parameters include at least one of: a number of beams, a number of frequency domain basis vectors, a codebook subset restriction and a rank restriction.

Embodiment C1. A wireless device, WD, configured to communicate with a network node, the WD configured to, and/or comprising a radio interface and/or processing circuitry configured to:
receive a first set of codebook configuration parameters and a second set of codebook configuration parameters by higher layer signaling;
receive an updated set of codebook configuration parameters to update the second set of codebook configuration parameters, by control signaling; and
determine a codebook configuration based at least in part on the first set of codebook configuration parameters and the updated set of codebook configuration parameters.

Embodiment C2. The WD of Embodiment C1, wherein the higher layer signaling is radio resource control, RRC, signaling and/or the control signaling includes at least one of downlink control information, DCI and at least one medium access control, MAC, control element, CE.

Embodiment C3. The WD of any of Embodiments C1 and C2, wherein the WD, radio interface and/or processing circuitry are further configured to signal recommended codebook configuration parameters to the network node to update the second set of configuration parameters.

Embodiment C4. The WD of any of Embodiments C1-C3, wherein the WD radio interface and/or processing circuitry are further configured to receive a channel state information, CSI, report payload size indication that is based at least in part on the updated set of codebook configuration parameters.

Embodiment C5. The WD of any of Embodiments C1-C, wherein the second set of codebook configuration parameters and the updated codebook configuration parameters include at least one of: a number of beams, a number of frequency domain basis vectors, a codebook subset restriction and a rank restriction.

Embodiment D1. A method implemented in a wireless device, WD, the method comprising:
receiving a first set of codebook configuration parameters and a second set of codebook configuration parameters by higher layer signaling;
receiving an updated set of codebook configuration parameters to update the second set of codebook configuration parameters by control signaling; and
determining a codebook configuration based at least in part on the first set of codebook configuration parameters and the updated set of codebook configuration parameters.

Embodiment D2. The method of Embodiment D1, wherein the higher layer signaling is radio resource control, RRC, signaling and/or the control signaling includes at least one of downlink control information, DCI and at least one medium access control, MAC, control element, CE.

Embodiment D3. The method of any of Embodiments D1 and D2, further comprising signaling recommended codebook configuration parameters to the network node to update the second set of configuration parameters.

Embodiment D4. The method of any of Embodiments D1-D3, further comprising receiving a channel state information, CSI, report payload size indication that is based at least in part on the updated set of codebook configuration parameters.

Embodiment D5. The method of any of Embodiments D1-D4, wherein the second set of codebook configuration parameters and the updated codebook configuration parameters include at least one of: a number of beams, a number of frequency domain basis vectors, a codebook subset restriction and a rank restriction.

1. A method implemented in a wireless device, WD, the method comprising:
receiving, by higher layer signaling from a network node, a first set of channel state information, CSI, feedback generation configuration parameters and a second set of CSI feedback generation configuration parameters;
receiving, by control signaling from the network node, an updated set of CSI feedback generation configuration parameters to update the second set of CSI feedback generation configuration parameters; and
determining a CSI feedback generation configuration based at least in part on the first set of CSI feedback generation configuration parameters and the updated set of CSI feedback generation configuration parameters.

2. The method of claim 1, further comprising:
calculating CSI based on the determined CSI feedback generation configuration; and
reporting, to the network node, the calculated CSI.

3. The method of claim 1, further comprising signaling, to the network node, recommended CSI feedback generation configuration parameters for the network node to update the second set of CSI feedback generation configuration parameters.

4. The method of claim 1, further comprising receiving, from the network node, at least one of a physical uplink shared channel, PUSCH, resource allocation and a physical uplink control channel, PUCCH, resource allocation for CSI reporting, adapted according to the updated set of CSI feedback generation configuration parameters.

5. The method of claim 1, wherein the CSI feedback generation configuration is a codebook configuration.

6. The method of claim 1, wherein the CSI feedback generation configuration is a CSI feedback generation configuration for CSI feedback using autoencoders.

7. The method of claim 1, wherein one or more bits indicate which parameters from the second set of CSI feedback generation configuration parameters that are included in the updated set of CSI feedback generation configuration parameters.

8. (canceled)

9. The method of claim 1, wherein one or both of the second set of CSI feedback generation configuration parameters and the updated CSI feedback generation configuration parameters include at least one of: a number of beams, a number of frequency domain basis vectors, a codebook parameter combination, a number of selected CSI-RS ports, a number of precoder matrix indicator sub-bands per channel quality indication sub-band, a codebook subset restriction, a rank restriction, a model ID, a quantity for a given feature, a compression ratio, and a loss function.

10. A method implemented in a network node configured to communicate with a wireless device, WD, the method comprising:
signaling, by higher layer signaling to the WD, a first set of channel state information, CSI, feedback generation configuration parameters and a second set of CSI feedback generation configuration parameters; and
signaling, by control signaling to the WD, an updated set of CSI feedback generation configuration parameters to update the second set of CSI feedback generation configuration parameters.

11. The method of claim 10, further comprising determining the updated set of CSI feedback generation configuration parameters based on channel information.

12. The method of claim 11, wherein the channel information is based on uplink channel measurements, or a CSI report received from the WD.

13. The method of claim 10, further comprising:
receiving, from the WD, recommended CSI feedback generation configuration parameters; and
determining the updated set of CSI feedback generation configuration parameters based at least in part on the recommended CSI feedback generation configuration parameters.

14. The method of claim 10, further comprising receiving, from the WD, CSI reporting.

15. The method of claim 10, further comprising determining at least one of a physical uplink shared channel, PUSCH, resource allocation and a physical uplink control channel, PUCCH, resource allocation for CSI reporting by the WD, based on the updated set of CSI feedback generation configuration parameters.

16. The method of claim 10, wherein the CSI feedback generation configuration is a codebook configuration.

17. (canceled)

18. The method of claim 10, wherein one or more bits indicate which parameters from the second set of CSI feedback generation configuration parameters that are included in the updated set of CSI feedback generation configuration parameters.

19. (canceled)

20. (canceled)

21. A wireless device, WD, configured to communicate with a network node, the WD comprising one or both of a radio interface and processing circuitry to configure the WD to:
receive, by higher layer signaling from the network node, a first set of channel state information, CSI, feedback generation configuration parameters and a second set of CSI feedback generation configuration parameters;
receive, by control signaling from the network node, an updated set of CSI feedback generation configuration parameters to update the second set of CSI feedback generation configuration parameters; and
determine a CSI feedback generation configuration based at least in part on the first set of CSI feedback generation configuration parameters and the updated set of CSI feedback generation configuration parameters.

22. The WD of claim 21, wherein the one or both of the radio interface and the processing circuitry further configure the WD to:
calculate CSI based on the determined CSI feedback generation configuration; and
report, to the network node, the calculated CSI.

23. A network node configured to communicate with a wireless device, WD, comprising one or both of a radio interface and processing circuitry configured to configure the network node to:
signal, by higher layer signaling to the WD, a first set of channel state information, CSI, feedback generation configuration parameters and a second set of CSI feedback generation configuration parameters; and
signal, by control signaling to the WD, an updated set of CSI feedback generation configuration parameters to update the second set of CSI feedback generation configuration parameters.

24. The network node of claim 23, wherein one or both of the radio interface and the processing circuitry further configure the network node to determine the updated set of CSI feedback generation configuration parameters based on channel information.
